(19) United States
(12) Patent Application Publication
(10) Pub. No.: US 2009/0265412 A1
(43) Pub. Date: Oct. 22, 2009

(54) Plural Computer System

(76) Inventor: Eric Hainzer, Woodbridge, VA (US)

Correspondence Address: Charles L. Riddle, Esq., 434 Lackawanna Ave, Suite 200, Scranton, PA, 19465, US

(21) Appl. No.: 12/468,255

(22) Filed: May 19, 2009

Related U.S. Application Data
(63) Continuation-in-part of application No. 12/397,328, filed on Mar. 3, 2009.
(60) Provisional application No. 61/033,276, filed on Mar. 3, 2008.

(51) Int. Cl. G06F 15/16; G06F 21/00

(52) U.S. Cl. 709/200; 726/1; 709/223

(57) ABSTRACT

A plural-computer system for operating more than one computer comprising an enclosure a plurality of computers contained within the enclosure, each computer having a processor, memory, information storage, an operating system, a network interface, an user input socket and a user output socket and sufficiently interconnected to enable each computer to independently operate as desired, the system further having a KVM switch contained within the enclosure, pre-wired connected to the user input socket and the user output socket of each of the plurality of computers for connecting the plurality of computers with a keyboard, a display device, and a mouse/pointing device, and the system having a power supply contained within the enclosure having a source lead extending from the enclosure for connecting with a receptacle to receive power from a power source, the power supply further having at least one supply lead connected to the power supply and connected to each of the plurality of computers for providing the computers with power.

### CROSS-REFERENCE TO RELATED APPLICATIONS

This application is a continuation-in part application, which claims priority of non-provisional application Ser. No. 12/397,328 filed on Mar. 3, 2009, which claims priority of provisional application No. 61/033,276 filed on Mar. 3, 2008.

### BACKGROUND OF THE INVENTION

1. Field of the Invention

The present invention relates to computers, in particular, a system having a plurality of computers contained in a single enclosure and sharing, a single power supply among the plurality of computers wherein the enclosure is plugged into a single outlet. The plurality of computers also are configurable share one keyboard, one display and one mouse.

The present invention also relates to methods for deployment of computing centers where each user needs access to multiple computers with each computer independently running on a separate network.

The present invention also relates to efficient methods of interfacing with digital information provided on a plurality of disparate networks.

Often multiple computers are needed by a user at a workstation to perform the desired functions of an endeavor at a site, such as government operations centers, emergency management centers, training sites, classrooms, central information centers and the like.

Similarly, many computer networks require separate computers. This is true for national security, hospitals, and other critical areas where systems must maintain segregation. For example, many Department of Defense networks require different PCs for each network due to the security classification of information and the procedures to segregate classes of information.

Presently, users are often required to have more than one computer operating simultaneously. The set up of a plurality of computers consumes significant amounts of space with each computer requiring a power source, keyboard, monitor, and mouse. The conventional setup also places a high demand in IT setup time. Today, three or four PCs under a desk creates a wire mess due to lack of space. Even laptops take up space when using two or three at the same time. IT professionals must spend time with wires, un-boxing and boxing up items—time that can be better spent. In classrooms and operations areas this time can be expensive in terms of staffing and set up costs.

The present invention provides users with a plural computing system that is less cumbersome to set up, takes up less space, reduces the amount of cabling needed to set up, and uses less power. This out of the box solution is the next computer solution for applications that have disparate network applications, and other intensive applications that require separate computers for each application.

2. Brief Description of the Prior Art

Presently, a plural or multiple computer system is configured by having two, three and sometimes four or more computer systems all set up and running in one workspace. These computers are often towers, and the cabling between and among the towers to the outlets, keyboard, display, and mouse is messy and takes up space, and makes using the workspace cumbersome. The use of a KVM switch allows multiple computers to connect to one keyboard, display, and mouse, and frees up some space in not having to use multiple sets of monitors, keyboards, and mice, but much of the problem is with setting up the multiple stand alone computers and all the interconnecting cabling. Accordingly, there is a need to resolve the drawbacks by providing a multiple computer system that is relatively easy to set up and use, takes up less space, and may use less energy.

Typical steps for setting up a single workstation for a single user using two separate computers involve the following steps: Providing and unpacking one mouse, one monitor, one keyboard, one KVM switch, one KVM power supply, two power cords (one for each computer), one power cord for the monitor, two monitor extension cables, two keyboard extension cables, two mouse extension cables, two audio in extension cables, two audio out extension cables, two video/usb cables. Place the first and second computers proximate to a designated workspace. Place a KVM switch proximate to the designated workspace. Place the console items (keyboard, mouse, monitor, microphones, speakers, video) proximate to the workspace, and connect the console items to the KVM switch. Connect the first and second computers to the KVM switch using the extension cables. Provide adequate access to power outlets in the form of outlets, extension cords and/or power strips. Connect power cables to the power strip from the first and second computers and the monitor and the KVM switch if needed. Connect the power strip to an outlet. Connect each computer to a network cable or wireless network adapter.

For a three or four computer workstation the steps multiply accordingly. If the number of workstations increase, the amount of parts and procedures, and power demands increase in multiples. Such a typical setup is intensive and cumbersome.

### SUMMARY OF THE INVENTION

This invention relates to a system for operating a plurality of computers. The plurality of computers share a single enclosure by being contained within said enclosure and interconnected or pre-wired together and to a KVM switch, which is also contained within said enclosure. With a built in KVM switch, the user operates only one keyboard, monitor, and mouse by toggling between each separate computer. The user operates a KVM switch included in the system and allows access to each computer one at a time. The plurality of computers share a single power source/brick/transformer or single power cord, a keyboard, a display and a mouse. One power connection cord from the enclosure to the AC source, for example, provides electricity to each computer via internal power distribution. So the facility does not require an upgrade to handle all the wiring needed in conventional setups, fewer outlets are employed to power many plural/multi computers. Inherent in this disclosure is a method of setting up and using a plural computer system.

### Objects and Advantages

With multiple motherboards or processor modules in one enclosure, users have the ability to access disparate and completely separate networks in a smaller and more compact design. The invention configures multiple motherboards into one enclosure with one external power connection as its energy source. Adding additional features such as a build-in monitor, switch, mouse, keyboard, and sound makes the entire array of technology smaller, less intensive to set up and use, and more energy efficient. The KVM switch may be a physical device mounted internal or external or a software control where two or more computers are able to switch between each other.

a. Government Energy Mandates —Laws, statutes, legislation, and codes at the federal, state, and local levels are intended to conserve energy consumption of their employees electronic devices. Consuming less electricity also helps reduce the air conditioning and cooling of facility buildings due to reduction of total heat output.

b. Space—The desktop, tower, and laptop computers are individual stand-alone units intended for use by various users. But today, information assurance and network security officers require their users to access their networks with a computer that has its own processor, hard drive, memory, and components. This insures there is no possibility of compromising information from one network or domain to another. Switchblade allows for number of different computers for the user to access at a fraction of the space it would normally take to accomplish the same technical task while still meeting the separation imposed by directives and regulations.

c. Setup/Standardization of Parts—Other inherent features of combining multiple computers into one enclosure is elimination of complex setup cabling and significantly reducing set-up time. With all interconnections made internal to the enclosure there is no possibility of tampering or inadvertently disconnecting devices from each other. Standardization of parts is embedded in the design because al the physical components are identical. Using a wide assortment of various brands and models of different computers force technicians to maintain a wide assortment of parts for each computer in use. Standardizing on one platform eliminates the need for maintaining parts and inventory for different computers in use.

### BRIEF DESCRIPTION OF THE DRAWINGS

FIG. 1 is a schematic of the plural computer system.

FIG. 2 is a rear plan view of one embodiment of a plural computer system.

FIG. 3 is a limited schematic of basic computer components used in the system.

FIG. 4 is a front isometric view of the plural computer system.

FIG. 5 is a rear isometric view of the plural computer system.

### DETAILED DESCRIPTION OF SEVERAL EMBODIMENTS

A preferred embodiment of the invention is shown in the following illustrated example, and is not intended to be limiting.

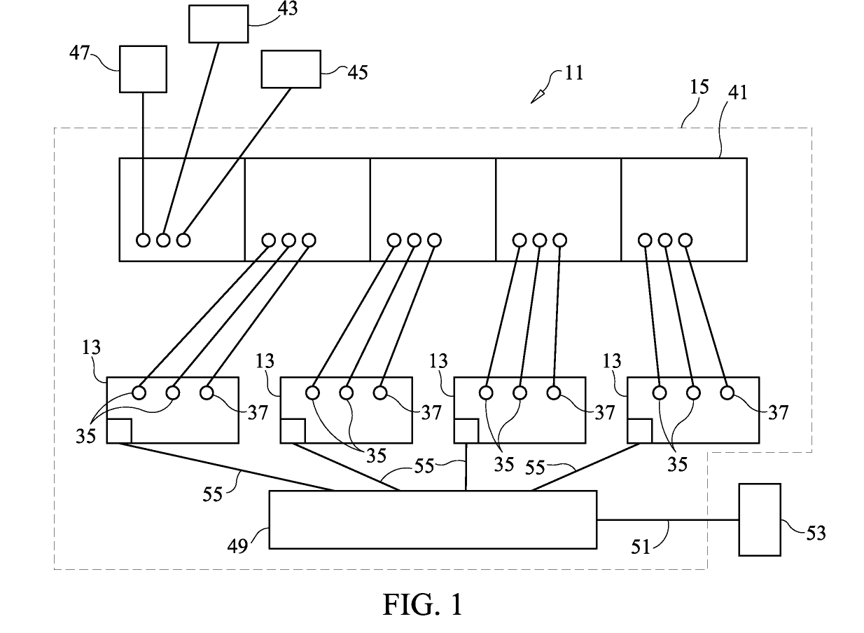

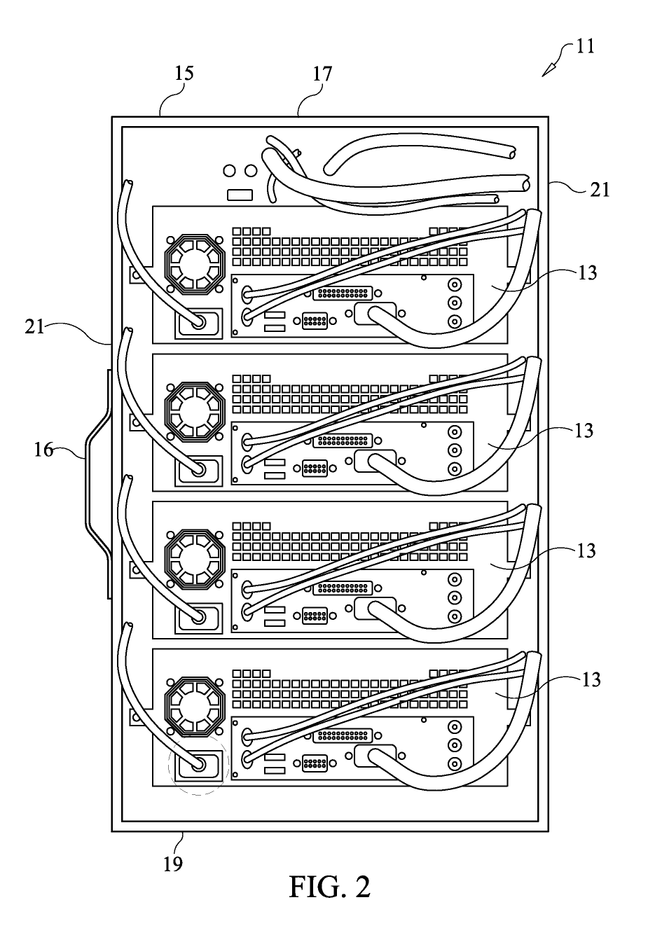

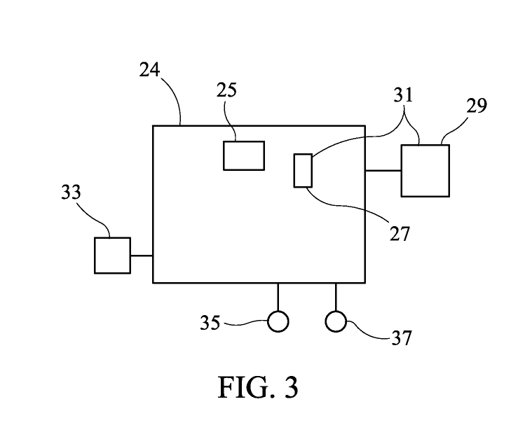

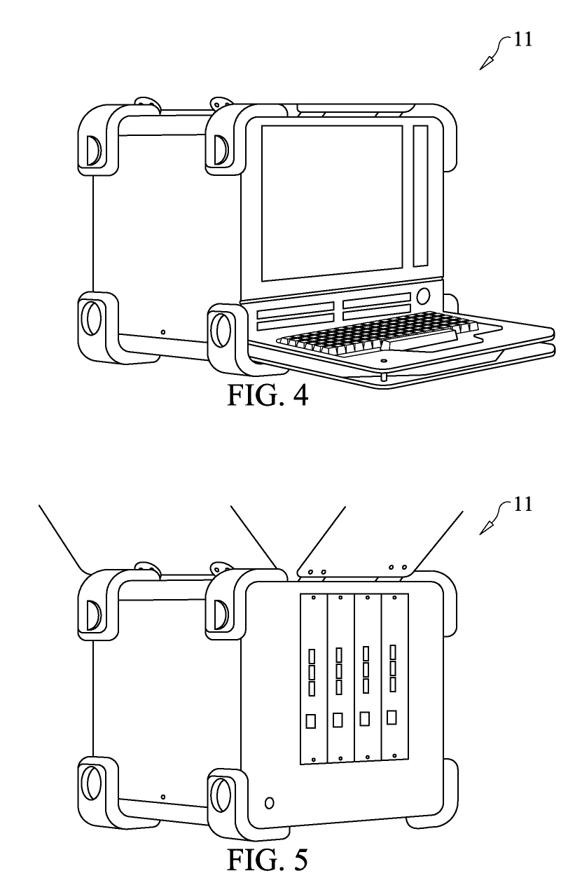

Turning now to the drawings, there is shown in FIGS. 1-2 a plural computer system 11 for operating more than one computer 13. The plural computer system 11 comprising, an enclosure 15 having a top 17, a bottom 19, and four sides 21 connecting the top 17 to the bottom 19. The enclosure 15, preferably is constructed of a lightweight durable material such as aluminum or a plastic, and has a handle 16 for moving the enclosure 15.

Contained within the enclosure 15 are a plurality of computers 13. Each computer 13 having a motherboard, a processor 25, memory 27, information storage 29, an operating system 31, a network interface 33, at least one user input socket 35 and at least one user output socket 37 sufficiently interconnected to one or more hardware components 39 to enable each computer 13 to independently operate as desired. The at least one user input socket 35 may be any port sufficient to read user input. For example USB, serial, parallel, audio or other ports are envisioned. Preferably USB is employed to read input such as keyboard, mouse, or audio input.

The at least one user output socket 37 may be any port sufficient to convey information via signals dent from the computer 13, and preferably include video output ports and audio output ports. The network interface 33 preferably is an ethernet card, but can be any network interface designed according to an interface standard needed.

Each computer 13 preferably is a commercial off the shelf or COTS type computer, such as that of a laptop, desktop or notebook computer, but other privately constructed, or less commercial computers may be used depending the application desired, so long as the computer used communicates with the KVM switch 41 (or an equivalent) discussed below. Computers 13 may be either small-form-factor (SFF) models or smaller more compact motherboards with embedded components.

The plural computer system 11 further includes a KVM switch 41, connected to the at least one user input socket 35 and the user output socket 37 of each of the plurality of computers 13, and the KVM switch 41 connected to a keyboard 43, a display device 45, and a mouse/pointing device 47. The KVM switch, or its equivalent allows a user to select which computer 13 of the plurality of computers 13 to operate.

The plural computer system 11 further has a power supply 49 having a source lead 51 for connecting with a receptacle 53 to receive power from a power source, the power supply 49 further having at least one supply lead 55 connected to the power supply 49 and connected to each of the plurality of computers 13 for providing the computers 13 with power. The power supply 49 preferably is a transformer that transforms ac outlet power to a dc voltage and amperage sufficient to operate each of the plurality of computers. The power supply 49 is contained within the enclosure 15, and the source lead 51, which extends outside of the enclosure 15, is a standard plug for connecting with 115-volt ac power. The supply lead 55 connects with each of the plurality of the computers 13, which are pre-wired to the supply lead 55 from the power supply 49.

Additional options which can be contained within or integral to the enclosure 15 include a Monitor—Visual output device, Keyboard/Mouse—Input device by which instructions are sent to the computer, DVD/USB—Drives or external ports for importing/exporting data, UPS—An Un-interruptible Power Supply (UPS) using a back-up battery, Camera/Speakers/Microphone for collaboration and videoconferencing, and/or Global Positioning System (GPS) for direction finding.

In an alternate embodiment, the enclosure 15 includes one or more empty bays, wherein one or more additional computers 13 can be installed into the system 11. Alternatively, the plurality of computers 13 may be selectively removable from the enclosure 15 for replacement, maintenance, or repair.

In use, one or more of the plurality of computers 13 are configured by including components or installing software that allows said computer 13 to communicate on a secure network, such as a private network, a corporate network, or a government network. Other computers 13 are configured by including components or installing software that allows said computer 13 to communicate on a non-secure or unclassified network. The configurations vary depending on the needed function. For example one computer 13 of the system 11 is configured to operate on a first government agency secure network, a second computer 13 of the system 11 is configured to operate on a second secure network of a second government agency, and a third computer 13 of the system 11 is configured to operate on the public internet Since each of the three computers 13 of the system 11 are operating independently of the others, the risk of compromising any secure network is diminished.

My invention includes a method of deploying a computing system 11 for allowing a user to work on a plurality of disparate networks. As discussed, government regulations, and corporate security rules often require that the computer operating on a private network be physically sequestered from other networks. In other words, the computer must not function on more than one network at a time. Accordingly, a user may have two or three computers set up at a workstation. First, a workspace is designated as a location for use as a workstation by a user. A console (keyboard, monitor mouse, speakers, USB/AV port, and other input/output devices) is provided at the workstation. The plural computer system 11 of the invention discussed herein is provided and attached to the console. A single power cord is attached to the system 11 and connected to an outlet. The monitor is also attached to an outlet. Network cables/wireless network devices are attached to one or more of the plurality of computers 13, and a plurality of computers 13 are powered up to operate independently of the other computers of the system 11. Depending on the type of work necessary, each of the computers of the plurality of computers 13 can be configured to communicatively function on a separate network.

Using the system 11, a user interacts with information provided on a plurality of computer networks using a single console. Once the plurality of computers 13 are powered and configured, the user connects a first computer of the system 11 to a first network from the console. Then the user connects a second or third computer to a second or third network from the console. Once connected, the user accesses, views, and or manipulates information provided on the first, second or third networks from the console. For example, from the console attached to the system 11 the user can access view and utilize information on the first network (a secure network, for example), make a decision on how to proceed, and input information on a second network (a second secure network that is sequestered from the first network) based on the information read from the first network. Another example is for training. For example, from the console, a user can face a problem presented on a private live network, access and test training simulations on a second secure private network, decide how to proceed and implement some responsive action on the private live network.

Many times the law enforcement and emergency response community have specific needs that only require two computers in one enclosure 15. In this configuration the enclosure contains two miniature computers, a common power supply, and switching ability between the two computers. Monitor and keyboard as well as a separate touch-panel display (TPD) are mounted in the vehicle for use by police and law enforcement personnel.

1. A plural-computer system for operating more than one computer comprising,
an enclosure having a top, a bottom, and four sides connecting the top to the bottom,
a plurality of computers contained within the enclosure, each computer having a processor, memory, information storage, an operating system, a network interface, an user input socket and a user output socket sufficiently interconnected to one or more hardware components to enable each computer to independently operate as desired,
a KVM switch, contained within the enclosure and connected to the user input socket and the user output socket of each of the plurality of computers for connecting the plurality of computers with a keyboard, a display device, and a mouse/pointing device, and
a power supply contained within the enclosure and having a source lead extending outside the enclosure for connecting with a receptacle to receive power from a power source, the power supply further having at least one supply lead connected to the power supply and connected to each of the plurality of computers for providing the computers with power.

2. The plural computer system of claim 1, one of the plurality of computers including components and or a software package which renders said one of the plurality of computers only communicatively operable with other computers on a secure network.

3. The plural computer system of claim 1, one of the plurality of computers including components and/or a software package that only allows external data communication on a first secure data network.

4. The plural computer system of claim 3, an other of the plurality of computers including components and/or a software package that allows external data communication on a second secure data network.

5. The plural computer system of claim 3, an other of the plurality of computers including components and/or a software package that allows external data communication on an unclassified and/or public network.

6. The plural computer system of claim 4, an other of the plurality of computers including components and/or a software package that allows external data communication on an unclassified and/or public network.

7. The plural computer system of claim 1, each computer of the plurality of computers including components and/or software so that each computer is configured to communicatively function on a separate network.

8. A method of deploying a computing system for allowing a user to work on a plurality of disparate networks, the method comprising the steps of:
designating a workspace for use as a workstation by a user;
providing a console at the workspace for allowing a user to interface with and/or communicate using one or more computers, the console comprising a keyboard, a monitor and a mouse;
providing a plural computer comprising a portable encasement containing a plurality of computers each configured to operate independent of an other of the plurality of computers, a shared power converter for converting ac power to dc power and distributing said dc power to each of the plurality of computers, and a console sharing device for allowing a user to interface with each of the plurality of computers using the console;
placing the plural computer proximate to the workspace;
connecting the console to the console sharing device of the plural computer system;
connecting the monitor to a power source;
connecting the shared power converter to a power source;
physically connecting a first network cable or a first wireless network transceiver to one of the plurality of computers;
physically connecting a second network cable or a second wireless network transceiver to an other of the plurality of computers;
powering up one of the plurality of computers; and
powering up an other of the plurality of computers.

9. The method of claim 8, further including the step of configuring each of the plurality of computers to communicatively function on a separate network.

10. A method of interacting with information provided on a plurality of computer networks using a single console comprising the steps of:
providing a plural computer comprising a portable encasement containing a plurality of computers each configured to operate independent of an other of the plurality of computers, a shared power converter for converting ac power to dc power and distributing said dc power to each of the plurality of computers, and a console sharing device for allowing a user to interface with each of the plurality of computers using the console;
connecting one of the plurality of computers to a first network;
connecting an other of the plurality of computers to a second network;
accessing and/or viewing and/or manipulating information provided only on the first network using the plural computer attached to the console and accessing and/or viewing and/or manipulating information provided only on the second network using the plural computer attached to the console.

11. The method of claim 10, wherein the step of connecting one of the plurality of computers to a first network further includes installing a first network software package for enabling the one of the plurality of computers to communicate data on the first network according to a designated protocol assigned to the first network.

12. The method of claim 11, wherein the step of connecting an other of the plurality of computers to a second network further includes installing a second network software package, the second network software package being operatively and/or communicatively incompatible with either the first network and/or the one of the plurality of computers with the first network software installed.

13. The method of claim 10, wherein the first network and the second network cannot be simultaneously accessed by a single computer.

14. The method of claim 11, wherein the first network and the second network are functionally distinct and/or not communicatively connectable either by government regulation and/or by physical/software means.

15. The method of claim 10, wherein the first network and the second network differ in, classification, and/or security level, and/or access permissions, and/or encryption protocol, and/or connection method, and/or network architecture, and/or network topology.

16. The method of claim 10, wherein the connecting one of the plurality of computers to a first network step includes implementing a first secure network protocol.

17. The method of claim 16, wherein the connecting an other of the plurality of computers to a second network step includes implementing a public domain network protocol.

18. The method of claim 10, wherein the connecting one of the plurality of computers to a first network step includes implementing a first secure network protocol for data communication on a training simulation network, and wherein the connecting an other of the plurality of computers to a second network step includes implementing a second secure network protocol for data communication on a live network.

19. The method of claim 10, wherein the connecting one of the plurality of computers to a first network step includes implementing a first secure network protocol specified by a first government agency, the connecting an other of the plurality of computers to a second network step includes implementing a second secure network protocol specified by a second agency, and implementing an third network protocol on a third computer of the plurality of computers wherein the third network protocol is functionally distinct and networkably inoperable from the first network, and the second network.

20. The method of claim 10, further including viewing first secure network information displayed on the console from one of the plurality of computers of the plural computer and passing assimilated information to the second secure network by toggling the console to operate on the other of the plurality of computers of the plural computer and imputing said assimilated information into the console.
